(19) United States
(12) Patent Application Publication
(10) Pub. No.: US 2026/0237745 A1
(43) Pub. Date: Aug. 13, 2026

(54) SOLID-STATE BATTERY

(71) Applicant: FDK CORPORATION, Tokyo (JP)

(72) Inventors: Masakazu KOBAYASHI, Tokyo (JP); Satoshi HIGUCHI, Tokyo (JP); Minako SUZUKI, Tokyo (JP)

(73) Assignee: FDK CORPORATION, Tokyo (JP)

(21) Appl. No.: 19/153,957

(22) PCT Filed: Oct. 26, 2023
(86) PCT No.: PCT/JP2023/038624

§ 371 Date: Aug. 5, 2025

(30) Foreign Application Priority Data
Feb. 8, 2023 (JP) 2023-017914

(51) Int. Cl. H01M 10/0585; H01M 10/0562; H01M 50/586

(52) U.S. Cl. CPC H01M 10/0585; H01M 10/0562; H01M 50/586

(57) ABSTRACT

An occurrence of a crack is prevented. The solid-state battery (1) includes: a battery body (2) including a laminate (40) in which a first electrode layer (10) and a second electrode layer (20) are laminated in a first direction (D1) with an electrolyte layer (30) interposed therebetween and an insulating layer (50) covering the laminate (40); and an external electrode (3) provided on a first end surface (2a) of the battery body 2, the first end surface (2a) facing a second direction (D2) orthogonal to the first direction (D1). In a cross-sectional view taken along the second direction (D2), an edge (11) of the first electrode layer (10) on a first end surface (2a) side is located on the first end surface (2a), an edge (21) of the second electrode layer (20) on the first end surface (2a) side is located inside the first end surface (2a), and a thickness (T1a) of a non-facing portion (61a) of the first electrode layer (10) and the second electrode layer (20) on the first end surface (2a) side is 0.93 times or more and 0.99 times or less a thickness (T2) of a facing portion (62) of the first electrode layer (10) and the second electrode layer (20) on an inner side. The same applies to a second end surface (2b) side.

### TECHNICAL FIELD

The present invention relates to a solid-state battery.

### BACKGROUND ART

For example, there has been an all-solid-state battery including a battery body having first and second internal electrodes facing each other with a solid electrolyte layer interposed therebetween, a first insulating layer provided on one end surface side of the first internal electrode, and a second insulating layer provided on the other end surface side of the second internal electrode (Patent Literature 1). Regarding the solid-state battery, a technique is known in which a thickness of each of a first edge portion of the battery body at which the first internal electrode, the solid electrolyte layer, and the second insulating layer are provided and a second edge portion of the battery body at which the second internal electrode, the solid electrolyte layer, and the first insulating layer are provided, is set to be 1.01 times or more and 1.15 times or less a thickness of a functional portion at which the first and second internal electrodes and the solid electrolyte layer are provided.

### CITATION LIST

### Patent Literature

Patent Literature 1: WO2019/167821 pamphlet

### SUMMARY OF INVENTION

### Technical Problem

As a solid-state battery, a solid-state battery including a battery body including a laminate in which a first electrode layer and a second electrode layer are laminated via an electrolyte layer and an insulating layer (also referred to as a cover layer) covering the laminate is known. In the solid-state battery, cracks may occur in the battery body during production or operation. The occurrence of the cracks may lead to a decrease in operation performance, a decrease in moisture resistance, and the like of the solid-state battery.

According to one aspect, an object of the present invention is to provide a solid-state battery in which an occurrence of a crack is prevented.

### Solution to Problem

In one aspect, there is provided a solid-state battery including:
a battery body including a laminate in which a first electrode layer and a second electrode layer are laminated in a first direction with an electrolyte layer interposed therebetween, and an insulating layer covering the laminate; and
an external electrode provided on a first end surface of the battery body, the first end surface facing a second direction orthogonal to the first direction, in which
in a cross-sectional view taken along the second direction of the battery body,
an edge of the first electrode layer on a first end surface side is located on the first end surface,
an edge of the second electrode layer on the first end surface side is located inside the first end surface, and
a thickness in the first direction of a non-facing portion which is located on the first end surface side and in which the first electrode layer and the second electrode layer do not face each other in the first direction is 0.93 times or more and 0.99 times or less a thickness in the first direction of a facing portion which is located inside the non-facing portion and in which the first electrode layer and the second electrode layer face each other in the first direction.

### Advantageous Effects of Invention

According to one aspect, it is possible to achieve a solid-state battery in which an occurrence of a crack is prevented.

The objects, features, and advantages of the present invention will become apparent from the following description of preferred embodiments as examples of the present invention, when read together with the accompany drawings.

### BRIEF DESCRIPTION OF DRAWINGS

FIG. 1 is a diagram (part 1) illustrating an example of a solid-state battery.

FIG. 2 is a diagram (part 2) illustrating the example of the solid-state battery.

FIG. 3 is a diagram (part 3) illustrating the example of the solid-state battery.

### DESCRIPTION OF EMBODIMENTS

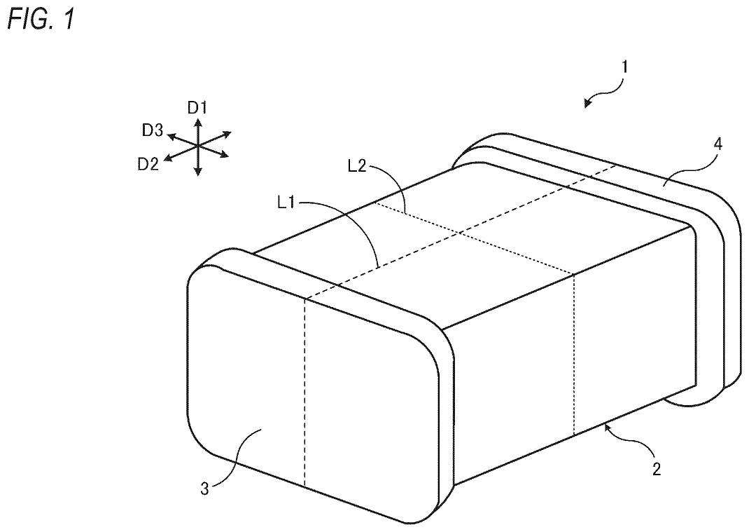

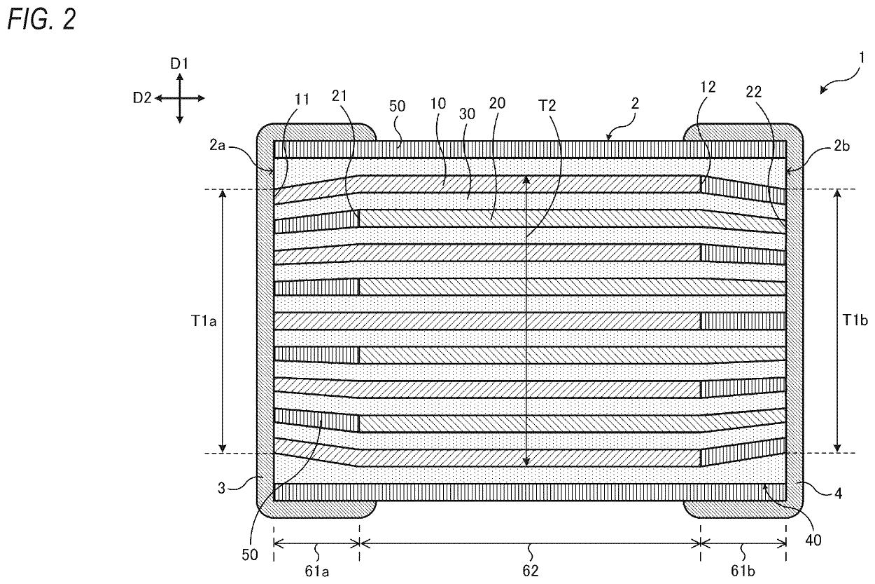

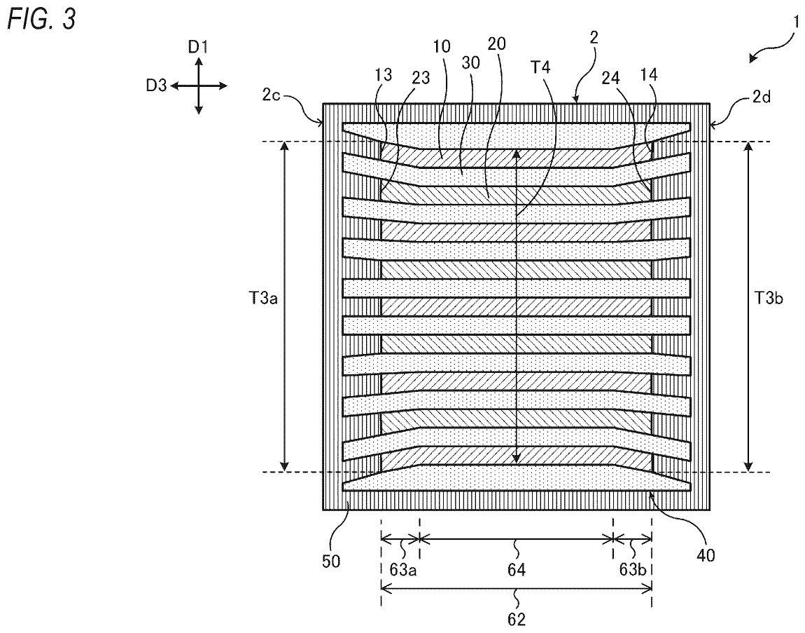

FIGS. 1 to 3 are diagrams illustrating an example of a solid-state battery. FIG. 1 is a schematic perspective view of the example of the solid-state battery. FIGS. 2 and 3 are schematic cross-sectional views of the example of the solid-state battery. FIG. 2 is the schematic cross-sectional view taken along a line L1 in FIG. 1. FIG. 3 is the cross-sectional view taken along a line L2 in FIG. 1.

As shown in FIG. 1, the solid-state battery 1 includes a battery body 2, and external electrodes 3 and 4 provided on the battery body 2.

As shown in FIGS. 2 and 3, the battery body 2 includes a laminate 40 including a first electrode layer 10, a second electrode layer 20, and an electrolyte layer 30 provided between the first electrode layer 10 and the second electrode layer 20. The first electrode layer 10 and the second electrode layer 20 are laminated in a direction D1 with the electrolyte layer 30 interposed therebetween. For example, the plurality of first electrode layers 10 and the plurality of second electrode layers 20 are alternately laminated in the direction D1 with the electrolyte layer 30 interposed therebetween. A top layer and a bottom layer of the laminate 40 may be the first electrode layer 10 or the second electrode layer 20, or may be the electrolyte layer 30 as shown in FIGS. 2 and 3. One of the first electrode layer 10 and the second electrode layer 20 is a positive electrode layer, and the other is a negative electrode layer. That is, the first electrode layer 10 is a positive electrode layer and the second electrode layer 20 is a negative electrode layer, or the first electrode layer 10 is a negative electrode layer and the second electrode layer 20 is a positive electrode layer.

The battery body 2 further includes an insulating layer 50 covering the laminate 40. The insulating layer 50 is also referred to as a cover layer. In the insulating layer 50, a portion adjacent to a side of the first electrode layer 10 and a portion adjacent to a side of the second electrode layer 20 between the facing electrolyte layers 30 are also referred to as buried layers.

Here, the electrolyte layer 30 of the laminate 40 of the battery body 2 contains a solid electrolyte. As the solid electrolyte of the electrolyte layer 30, for example, an oxide solid electrolyte is used. As the oxide solid electrolyte of the electrolyte layer 30, for example, LAGP, which is a type of Na super ionic conductor (NASICON) type oxide solid electrolyte, is used. LAGP is an oxide solid electrolyte represented by a general formula Li₁₊ₓAlₓGe₂₋ₓ(PO₄)₃ (0<x≤1). In addition, a sulfide solid electrolyte such as lithium sulfide (Li₂S)-phosphorus pentasulfide (P₂S₅) may be used as the solid electrolyte of the electrolyte layer 30.

The positive electrode layer (first electrode layer 10 or second electrode layer 20) of the laminate 40 of the battery body 2 contains a positive electrode active material, a conductive assistant, and a solid electrolyte. As the solid electrolyte of the positive electrode layer, an oxide solid electrolyte or a sulfide solid electrolyte, for example, the same material as the solid electrolyte used in the electrolyte layer 30 is used. For the positive electrode active material of the positive electrode layer, lithium cobalt pyrophosphate (Li₂CoP₂O₇, hereinafter, also referred to as “LCPO”) is used. For the conductive assistant of the positive electrode layer, a carbon material such as carbon fiber, carbon black, graphite, graphene, or carbon nanotubes, or a conductive material such as iron silicide, is used, for example. The positive electrode layer is connected to one of the external electrode 3 and the external electrode 4 (one different from one to which the negative electrode layer is connected).

The negative electrode layer (second electrode layer 20 or first electrode layer 10) of the laminate 40 of the battery body 2 contains a negative electrode active material, a conductive assistant, and a solid electrolyte. As the solid electrolyte of the negative electrode layer, an oxide solid electrolyte or a sulfide solid electrolyte, for example, the same material as the solid electrolyte used in the electrolyte layer 30 is used. For the negative electrode active material of the negative electrode layer, for example, titanium oxide (TiO₂), niobium pentoxide (Nb₂O₅), or the like is used. In addition, for the negative electrode active material of the negative electrode layer, lithium vanadium phosphate (Li₃V₂ (PO₄)₃), lithium titanate (Li₄Ti₅O₁₂), or the like may be used. For the conductive assistant of the negative electrode layer, a carbon material such as carbon fiber, carbon black, graphite, graphene, or carbon nanotubes, or a conductive material such as iron silicide, is used, for example. The negative electrode layer is connected to one of the external electrode 3 and the external electrode 4 (one different from the one to which the positive electrode layer is connected).

In the laminate 40 of the battery body 2 of the solid-state battery 1, lithium ions move from the positive electrode layer (first electrode layer 10 or second electrode layer 20) to the negative electrode layer (second electrode layer 20 or first electrode layer 10) via the electrolyte layer 30 during charging, whereas the lithium ions move from the negative electrode layer to the positive electrode layer via the electrolyte layer 30 during discharging. In the battery body 2 of the solid-state battery 1, charging and discharging operation are achieved by such lithium ion conduction in the laminate 40.

Various materials having an insulating property are used for the insulating layer 50. An insulating property of a material used for the insulating layer 50 refers to a property that has no effect on lithium ion conduction and electron conduction in the laminate 40 or has a sufficiently low effect. The insulating layer 50 is preferably made of a material that has low moisture and gas permeability and a good sealing property. Among these, those having a linear expansion coefficient similar to that of each layer constituting the laminate 40 of the battery body 2 or those having good adhesion to each layer are preferable. Glass, ceramics, a solid electrolyte, or the like is used as the material of the insulating layer 50.

Various conductor materials are used for the external electrode 3 and the external electrode 4. For example, as the external electrode 3 and the external electrode 4, a material obtained by drying and curing a conductive paste containing conductive particles such as metal particles of silver (Ag), copper (Cu), nickel (Ni), or the like or carbon particles, or a material formed by depositing various metals using a sputtering method, a plating method, or the like is used.

As shown in FIG. 2, the battery body 2 has an end surface 2a and an end surface 2b which face a direction D2 orthogonal to the direction D1 in which the first electrode layer 10, the electrolyte layer 30, and the second electrode layer 20 of the laminate 40 are laminated. The battery body 2 has the following arrangement in a cross section (also referred to as a “first cross section”) along the direction D2 as shown in FIG. 2.

An edge 11 of the first electrode layer 10 on an end surface 2a side is located on the end surface 2a without being covered with the insulating layer 50. An edge 12 of the first electrode layer 10 on an end surface 2b side is covered with the insulating layer 50 and is located inside the end surface 2b.

An edge 21 of the second electrode layer 20 on the end surface 2a side is covered with the insulating layer 50 and is located inside the end surface 2a. An edge 22 of the second electrode layer 20 on the end surface 2b side is located on the end surface 2b without being covered with the insulating layer 50.

The external electrode 3 is provided on the end surface 2a where the edge 11 of the first electrode layer 10 is located, and is electrically connected to the first electrode layer 10. The first electrode layer 10 is separated from the external electrode 4 by the insulating layer 50 provided on an edge 12 side, and is electrically separated from the external electrode 4.

The external electrode 4 is provided on the end surface 2b where the edge 22 of the second electrode layer 20 is located, and is electrically connected to the second electrode layer 20. The second electrode layer 20 is separated from the external electrode 3 by the insulating layer 50 provided on an edge 21 side, and is electrically separated from the external electrode 3.

The direction D1 is also referred to as a “first direction”, and the direction D2 is also referred to as a “second direction”. The end surface 2a or the end surface 2b of the battery body 2 is also referred to as a “first end surface”.

Further, the end surface 2a and the end surface 2b are also referred to as “electrode lead-out surfaces”. When the first electrode layer 10 having the edge 11 located on the end surface 2a is the positive electrode layer, the end surface 2a is also referred to as a “positive electrode lead-out surface”, and when the first electrode layer 10 is the negative electrode layer, the end surface 2a is also referred to as a “negative electrode lead-out surface”. When the second electrode layer 20 having the edge 22 located on the end surface 2b is the negative electrode layer, the end surface 2b is also referred to as a “negative electrode lead-out surface”, and when the second electrode layer 20 is the positive electrode layer, the end surface 2b is also referred to as a “positive electrode lead-out surface”.

Portions of the first electrode layer 10 and the second electrode layer 20 laminated in the direction D1 with the electrolyte layer 30 interposed therebetween on the end surface 2a side and the end surface 2b side, at which the first electrode layer 10 and the second electrode layer 20 do not face each other in the direction D1, are also referred to as “non-facing portions” or a “non-facing portion 61a” and a “non-facing portion 61b”, respectively. A portion inside the non-facing portion 61a and the non-facing portion 61b, at which the first electrode layer 10 and the second electrode layer 20 face each other in the direction D1, is also referred to as a “facing portion” or a “facing portion 62”.

As shown in FIG. 3, the battery body 2 has an end surface 2c and an end surface 2d facing in a direction D3 orthogonal to the direction D1 and the direction D2. The battery body 2 has the following arrangement in a cross section (also referred to as a “second cross section”) along the direction D3 as shown in FIG. 3.

An edge 13 of the first electrode layer 10 on an end surface 2c side is covered with the insulating layer 50 and is located inside the end surface 2c. An edge 14 of the first electrode layer 10 on an end surface 2d side is covered with the insulating layer 50 and is located inside the end surface 2d.

An edge 23 of the second electrode layer 20 on the end surface 2c side is covered with the insulating layer 50 and is located inside the end surface 2c. An edge 24 of the second electrode layer 20 on the end surface 2d side is covered with the insulating layer 50 and is located inside the end surface 2d.

The direction D3 is also referred to as a “third direction”. The end surface 2c or the end surface 2d of the battery body 2 is also referred to as a “second end surface”.

In the facing portion 62 at which the first electrode layer 10 and the second electrode layer 20 face each other in the direction D1, portions on the end surface 2c side and the end surface 2d side are also referred to as “end portions” or an “end portion 63a” and an “end portions 63b”, respectively. In the facing portion 62 at which the first electrode layer 10 and the second electrode layer 20 face each other in the direction D1, a portion inside the end portion 63a and the end portion 63b is also referred to as a “central portion” or a “central portion 64”.

In the solid-state battery 1, in the cross-sectional view taken along the direction D2, that is, in the first cross section taken along the direction D2 as shown in FIG. 2, a thickness T1a of the non-facing portion 61a in the direction D1 and a thickness T1b of the non-facing portion 61b in the direction D1 are adjusted to be 0.93 times or more and 0.99 times or less a thickness T2 of the facing portion 62 in the direction D1. That is, the adjustment is performed such that 0.93≤T1a/T2≤0.99 and 0.93≤T1b/T2≤0.99. For example, the thickness T1a of the non-facing portion 61a in the direction D1 is a thickness in the direction D1 at a position of the end surface 2a, and the thickness T1b of the non-facing portion 61b in the direction D1 is a thickness in the direction D1 at a position of the end surface 2b. Accordingly, in the solid-state battery 1, an occurrence of a crack during firing performed in a production process and an occurrence of a crack due to expansion and contraction during charging and discharging are prevented.

Further, in the solid-state battery 1, in the cross-sectional view taken along the direction D3, that is, in the second cross section taken along the direction D3 as illustrated in FIG. 3, in the facing portion 62, a thickness T3a of the end portion 63a in the direction D1 and a thickness T3b of the end portion 63b in the direction D1 are adjusted to be 1.01 times or more and 1.07 times or less a thickness T4 of the central portion 64 in the direction D1. That is, the adjustment is performed such that 1.01≤T3a/T4≤1.07 and 1.01≤T3b/T4≤1.07. For example, the thickness T3a of the end portion 63a in the direction D1 is a thickness in the direction D1 at a position of the edge 13 or 23, and the thickness T3b of the end portion 63b in the direction D1 is a thickness in the direction D1 at a position of the edge 14 or 24. Accordingly, in the solid-state battery 1, the occurrence of the crack during the firing and the charging and discharging as described above is effectively prevented.

Such an effect of preventing the occurrence of the crack of the solid-state battery 1 will be further described later.

The solid-state battery 1 having the above-described configuration is produced, for example, using the following method.

### (Preparation of Paste)

### (Preparation of Positive Electrode Paste)

For example, 11.3 parts by mass of a LCPO powder as the positive electrode active material, 16.7 parts by mass of amorphous Li_{1.5}Al_{0.5}Ge_{1.5}(PO₄)₃ powder (also referred to as an “LAGPg powder”) as the solid electrolyte, 5.5 parts by mass of vapor growth carbon fiber powder (also referred to as a “VGCF powder”) as the conductive assistant, 7.8 parts by mass of polyvinyl butylal as the binder, 0.3 parts by mass of bis(2-ethylhexanoate)triethylene glycol as a plasticizer, 0.6 parts by mass of a specified dispersant, and 57.8 parts by mass of terpineol as a diluent are used. These are mixed in a ball mill for 72 hours, mixed and dispersed in a three-roll mill, and dispersed using a grind gauge until a material aggregate becomes 1 μm or less to obtain a positive electrode paste.

### (Preparation of Negative Electrode Paste)

For example, a negative electrode paste is obtained in the same manner as in the preparation of the positive electrode paste except that the same amount of anatase-type titanium oxide is used as the negative electrode active material instead of the positive electrode active material.

### (Preparation of Electrolyte Paste)

For example, 29.0 parts by mass of a LAGPg powder and 3.2 parts by mass of crystalline Li_{1.5}Al_{0.5}Ge_{1.5}(PO₄)₃ powder (also referred to as a “LAGPc powder”) as the solid electrolyte, 6.2 parts by mass of polyvinyl butylal as the binder, 2.2 parts by mass of bis(2-ethylhexanoate)triethylene glycol as a plasticizer. 0.3 parts by mass of a specified dispersant, and 59.1 parts by mass of terpineol as a diluent are used. These are mixed in a ball mill for 72 hours, mixed and dispersed in a three-roll mill, and dispersed using a grind gauge until a material aggregate becomes 1 μm or less to obtain an electrolyte paste.

### (Preparation of Insulating Paste)

For example, an insulating paste is obtained in the same manner as in the preparation of the electrolyte paste except that powders of glass or ceramics or both the powders are used in instead of the LAGPg and LAGPc powders in the electrolyte paste.

As the glass used for the insulating paste, glass containing components such as tin (Sn), boron (B), aluminum (Al), barium (Ba), zinc (Zn), silicon (Si), bismuth (Bi), phosphorus (P), sodium (Na), calcium (Ca), fluorine (F), vanadium (V), and zirconium (Zr) is used. Examples of the glass used for the insulating paste include SnO—B₂O₃—P₂O₅—Al₂O₃, SiO₂—B₂O₃—BaO—ZnO, SiO₂—B₂O₃—Bi₂O₃—ZnO, ZnO—Bi₂O₃—B₂O₃, SiO₂—Bi₂O₃, B₂O₃—P₂O₅—Na₂O—CaO—BaO-Al₂O₃, SnO—P₂O₅, SnO—B₂O₃—P₂O₅, SiO₂—SnO—P₂O₅, SiO₂—B₂O₃—R₂O, SiO₂—B₂O₃—ZnO—Na₂O—NaF—V₂O₅, SnO—ZnO—P₂O₅—R₂O—R2O, SiO₂—B₂O₃—ZnO, SiO₂—B₂O₃—Al₂O₃—ZrO₂, SiO₂—B₂O₃—ZnO—R₂O—R2O, and SiO₂—B₂O₃—Al₂O₃—R₂O—R2O (R is an alkali metal and R2 is an alkaline earth metal).

Examples of the ceramics used for the insulating paste include alumina, ferrite, zirconia, zircon, barium zirconate, calcium zirconate, titanium oxide, barium titanate, strontium titanate, calcium titanate, magnesium titanate, zinc titanate, lanthanum titanate, neodymium titanate, lead zirconate titanate, alumina nitride, silicon nitride, boron nitride, boron carbide, barium stannate, calcium stannate, magnesium silicate, mullite, steatite, cordierite, and forsterite.

Instead of the glass or ceramics, or together with the glass or ceramics, a solid electrolyte can also be used for the insulating paste.

### [Preparation of Solid-State Battery]

### (Preparation of Positive Electrode Mixture Layer Part)

For example, the electrolyte paste is pattern-printed on a polyethylene terephthalate (also referred to as “PET”) film by screen printing, and then dried at a temperature in a range of 80° C. to 95° C. for 10 minutes. Next, the insulating paste is printed around the pattern-printed electrolyte paste by the screen printing, and then dried at a temperature in a range of 80° C. to 95° C. for 10 minutes. The printing of the electrolyte paste and the insulating paste may be repeated a plurality of times until a desired thickness is achieved. The positive electrode paste is pattern-printed on the electrolyte paste and the insulating paste by the screen printing, and dried at a temperature in a range of 80° C. to 95° C. for 10 minutes. Next, the insulating paste is printed around the pattern-printed positive electrode paste by the screen printing, and then dried at a temperature in a range of 80° C. to 95° C. for 10 minutes. The printing of the positive electrode paste and the insulating paste may be repeated a plurality of times until a desired thickness is achieved. Accordingly, a positive electrode mixture layer part having a structure in which the PET film, an electrolyte mixture layer and an insulating mixture layer around the electrolyte mixture layer, and a positive electrode mixture layer and an insulating mixture layer around the positive electrode mixture layer are laminated is obtained.

### (Preparation of Negative Electrode Mixture Layer Part)

For example, a negative electrode mixture layer part is prepared in the same manner as the positive electrode mixture layer part except that the negative electrode paste is used instead of the positive electrode paste. Accordingly, a negative electrode mixture layer part having a structure in which a PET film, an electrolyte mixture layer and an insulating mixture layer around the electrolyte mixture layer, and a negative electrode mixture layer and an insulating mixture layer around the negative electrode mixture layer are laminated is obtained.

### (Preparation of Upper Surface Insulating Layer Part and Lower Surface Insulating Layer Part)

The insulating paste is printed solidly (over an entire surface) on the PET film, and then dried. The printing of the insulating paste may be repeated a plurality of times until a predetermined thickness is achieved. Accordingly, each of an upper surface insulating layer part and a lower surface insulating layer part having a structure in which the insulating mixture layer is laminated on the PET film is prepared.

### (Preparation of Battery Body)

The positive electrode (or negative electrode) mixture layer part is laminated on the insulating mixture layer of the lower surface insulating layer part such that the positive electrode (or negative electrode) mixture layer is in contact with the insulating mixture layer of the lower surface insulating layer part, and thermocompression bonding is performed to transfer the positive electrode (or negative electrode) mixture layer, the electrolyte mixture layer, and the insulating mixture layer around these mixture layers of the positive electrode (or negative electrode) mixture layer part.

Next, the negative electrode (or positive electrode) mixture layer part is laminated on the transferred positive electrode (or negative electrode) mixture layer, the electrolyte mixture layer, and the insulating mixture layer around these mixture layers such that the negative electrode (or positive electrode) mixture layer is in contact with the electrolyte mixture layer of the positive electrode (or negative electrode) mixture layer part, and thermocompression bonding is performed to transfer the negative electrode (or positive electrode) mixture layer, the electrolyte mixture layer, and the insulating mixture layer around these mixture layers of the negative electrode (or positive electrode) mixture layer part.

Such transfer of the positive electrode (negative electrode) mixture layer part and the negative electrode (positive electrode) mixture layer part is repeated until a predetermined number of layers are achieved. Thereafter, the insulating mixture layer of the upper surface insulating layer part is similarly laminated and transferred by the thermocompression bonding.

Conditions for the thermocompression bonding are, for example, a pressure in a range of 20 MPa to 100 MPa and a temperature of 70° C.

In this way, a basic structure of the battery body 2 is prepared. This is processed to have a predetermined plane dimension, for example, a plane dimension of 4.5 mm×3.2 mm. When the battery body 2 is processed to have the predetermined plane dimension, the processing is performed such that a part of a side surface of the positive electrode mixture layer is exposed on one end surface and a part of a side surface of the negative electrode mixture layer is exposed on the other end surface facing the one end surface. In the transfer of the positive electrode mixture layer part and the negative electrode mixture layer part, when the battery body 2 is processed to have the predetermined plane dimension, laminating positions of the positive electrode mixture layer and the negative electrode mixture layer (formation of an overlapping region or formation of the facing portion and the non-facing portion thereof) are adjusted such that the part of the side surface of the positive electrode mixture layer can be exposed on the one end surface and the part of the side surface of the negative electrode mixture layer can be exposed on the other end surface. In the battery body 2 obtained by the processing, the end surface where the part of the side surface of the positive electrode mixture layer is exposed is the positive electrode lead-out surface, and the end surface where the part of the side surface of the negative electrode mixture layer is exposed is the negative electrode lead-out surface.

After the prepared battery body 2 is processed, the battery body 2 is placed flat on a porous ceramic plate and heated at 500° C. for 5 hours in an atmosphere to perform debinding of a binder component. Further, the battery body 2 is heated at 600° C. for 2 hours in a nitrogen atmosphere to fire a solid electrolyte and the like contained therein. Accordingly, the battery body 2 of the solid-state battery 1 is prepared.

In the example of the solid-state battery 1, the electrolyte mixture layer in the prepared battery body 2 functions as the electrolyte layer 30 (FIGS. 2 and 3). One of the positive electrode mixture layer and the negative electrode mixture layer functions as the first electrode layer 10 (FIGS. 2 and 3), and the other functions as the second electrode layer 20 (FIGS. 2 and 3). The insulating mixture layer around the electrolyte mixture layer, the insulating mixture layer around the positive electrode mixture layer, and the insulating mixture layer around the negative electrode mixture layer function as the insulating layer 50 (FIGS. 2 and 3).

### (Preparation of External Electrodes)

External electrodes are respectively formed on the positive electrode lead-out surface, which is the end surface where the positive electrode mixture layer is exposed, and the negative electrode lead-out surface, which is the end surface where the negative electrode mixture layer is exposed, of the battery body 2 obtained as described above. Each of the external electrodes is formed by, for example, applying a main material containing Ag and then performing Ni plating and Sn plating on a surface thereof.

In the example of the solid-state battery 1, an external electrode formed on the end surface 2a where one of the positive electrode mixture layer and the negative electrode mixture layer which functions as the first electrode layer 10 is exposed, functions as the external electrode 3 (FIG. 2). An external electrode formed on the end surface 2b where the other of the positive electrode mixture layer and the negative electrode mixture layer which functions as the second electrode layer 20 is exposed, functions as the external electrode 4 (FIG. 2).

The solid-state battery 1 is prepared by the method as described above.

Hereinafter, Examples 1 to 5 and Comparative Examples 1 to 4 of the solid-state battery 1 and evaluations performed thereon will be described.

### Example 1

The solid-state battery 1 having a cross-sectional structure as shown in FIGS. 2 and 3 were prepared. That is, the solid-state battery 1 was prepared such that the thicknesses T1a and T1b of the non-facing portions 61a and 61b in the direction D1 were smaller than the thickness T2 of the facing portion 62 in the direction D1 in the first cross section (FIG. 2) taken along the direction D2, and the thicknesses T3a and T3b of the end portions 63a and 63b in the direction D1 were larger than the thickness T4 of the central portion 64 in the direction D1 in the second cross section (FIG. 3) taken along the direction D3 (Table 1).

In order to prepare such a solid-state battery 1, for example, the following method can be adopted.

In the preparation of the positive electrode mixture layer part, an emulsion thickness of a mask used at the time of printing the positive electrode paste or the surrounding insulating paste thereof, or an emulsion thickness of a mask used at the time of printing the electrolyte paste is adjusted. As an example, the emulsion thickness of the mask is adjusted in a range of 2 μm to 10 μm. Alternatively, in the preparation of the positive electrode mixture layer part, a saddle phenomenon occurring at the time of printing the positive electrode paste or the surrounding insulating paste thereof or a saddle phenomenon occurring at the time of printing the electrolyte paste is used. By using such a method, a relatively thick portion and a relatively thin portion are formed in the positive electrode mixture layer part.

In the preparation of the negative electrode mixture layer part, an emulsion thickness of a mask used at the time of printing the negative electrode paste or the surrounding insulating paste thereof, or an emulsion thickness of a mask used at the time of printing the electrolyte paste is adjusted. As an example, the emulsion thickness of the mask is adjusted in a range of 2 μm to 10 μm. Alternatively, in the preparation of the negative electrode mixture layer part, a saddle phenomenon occurring at the time of printing the negative electrode paste or the surrounding insulating paste thereof or a saddle phenomenon occurring at the time of printing the electrolyte paste is used. By using such a method, a relatively thick portion and a relatively thin portion are formed in the negative electrode mixture layer part.

For example, when such a method was used and the positive electrode mixture layer part and the negative electrode mixture layer part were laminated, thermocompression bonded, and subjected to dimensional processing to prepare the battery body 2, and the positive electrode mixture layer part and the negative electrode mixture layer part were prepared such that the above relationships were obtained between the thicknesses T1a and T1b and the thickness T2 and between the thicknesses T3a and T3b and the thickness T4. The prepared positive electrode mixture layer part and the negative electrode mixture layer part were laminated, thermocompression bonded, and subjected to dimensional processing to prepare the battery body 2, and the external electrodes 3 and 4 were prepared, thereby obtaining the solid-state battery 1 in Example 1.

In the solid-state battery 1 of Example 1, a drying temperature after the printing of the electrolyte paste, the positive electrode paste, the negative electrode paste, and the insulating paste in the preparation of the positive electrode mixture layer part and the negative electrode mixture layer part was set to 90° C. Furthermore, in the solid-state battery 1 of Example 1, conditions for the thermocompression bonding performed after laminating the lower surface insulating layer part, the positive electrode mixture layer part, the negative electrode mixture layer part, and the upper surface insulating layer part were set to 20 MPa and 70° C.

### Example 2

In the solid-state battery 1 of Example 2, a drying temperature after the printing of the electrolyte paste, the positive electrode paste, the negative electrode paste, and the insulating paste in the preparation of the positive electrode mixture layer part and the negative electrode mixture layer part was set in a range of 80° C. to 89° C. In addition, the production method and the conditions were the same as those in Example 1, and the solid-state battery I having a cross-sectional structure as shown in FIGS. 2 and 3 was prepared (Table 1).

### Example 3

In the solid-state battery 1 of Example 3, a drying temperature after the printing of the electrolyte paste, the positive electrode paste, the negative electrode paste, and the insulating paste in the preparation of the positive electrode mixture layer part and the negative electrode mixture layer part was set in a range of 91° C. to 95° C. In addition, the production method and the conditions were the same as those in Example 1, and the solid-state battery I having a cross-sectional structure as shown in FIGS. 2 and 3 was prepared (Table 1).

### Example 4

In the solid-state battery 1 of Example 4, conditions for the thermocompression bonding performed after laminating the lower surface insulating layer part, the positive electrode mixture layer part, the negative electrode mixture layer part, and the upper surface insulating layer part were set to 50 MPa and 70° C. In addition, the production method and the conditions were the same as those in Example 1, and the solid-state battery 1 having a cross-sectional structure as shown in FIGS. 2 and 3 was prepared (Table 1).

### Example 5

In the solid-state battery 1 of Example 5, conditions for the thermocompression bonding performed after laminating the lower surface insulating layer part, the positive electrode mixture layer part, the negative electrode mixture layer part, and the upper surface insulating layer part were set to 100 MPa and 70° C. In addition, the production method and the conditions were the same as those in Example 1, and the solid-state battery 1 having a cross-sectional structure as shown in FIGS. 2 and 3 was prepared (Table 1).

### Comparative Examples 1 to 4

Comparative Examples 1 to 4 were made in each of which the solid-state battery 1 was prepared such that the thicknesses T1a and T1b of the non-facing portions 61a and 61b in the direction D1 were larger than the thickness T2 of the facing portion 62 in the direction D1 in the first cross section (FIG. 2) taken along the direction D2, and the thicknesses T3a and T3b of the end portions 63a and 63b in the direction D1 were larger than the thickness T4 of the central portion 64 in the direction D1 in the second cross section (FIG. 3) taken along the direction D3 (Table 1).

### [Evaluation]

Fifty solid-state batteries 1 in each of Examples 1 to 5 and Comparative Examples 1 to 4 were prepared, and the number of cracks generated in a charge and discharge inspection was examined by a microscope and computed tomography (CT). Charge and discharge conditions were as follows. In an environment of 23° C., constant current charging was performed at 0.1 mA until a voltage reached 3.4 V, and after the voltage reached 3.4 V, constant voltage charging was performed for 5 hours. Thereafter, discharging was performed at a constant current of 0.1 mA and a cutoff voltage of 0 V in an environment of 23° C. This was regarded as one cycle, and a charge and discharge test was carried out for 30 cycles. Evaluation results are shown in Table 1.

TABLE 1

| | First cross section | | | | | Second cross section | | | | | Number of |
|---|---|---|---|---|---|---|---|---|---|---|---|
| | T2 | T1a | T1b | T1a/T2 | T1b/T2 | T4 | T3a | T3b | T3a/T4 | T3b/T4 | occurred cracks |
| | [μm] | [μm] | [μm] | [—] | [—] | [μm] | [μm] | [μm] | [—] | [—] | [pieces] |
| Example 1 | 933.4 | 909.1 | 902.6 | 0.97 | 0.97 | 933.4 | 949.3 | 981.2 | 1.02 | 1.05 | 0/50 |
| Example 2 | 938.7 | 915.9 | 907.0 | 0.98 | 0.97 | 938.7 | 950.9 | 984.1 | 1.01 | 1.05 | 0/50 |
| Example 3 | 922.7 | 909.3 | 900.0 | 0.89 | 0.98 | 922.7 | 965.9 | 987.1 | 1.05 | 1.07 | 0/50 |
| Example 4 | 936.9 | 915.9 | 916.9 | 0.88 | 0.98 | 936.9 | 978.0 | 984.3 | 1.04 | 1.05 | 0/50 |
| Example 5 | 914.0 | 847.0 | 877.0 | 0.93 | 0.96 | 914.0 | 968.9 | 970.6 | 1.06 | 1.06 | 0/50 |
| Comparative | 854.6 | 875.0 | 870.7 | 1.02 | 1.02 | 854.6 | 902.0 | 901.1 | 1.06 | 1.05 | 4/50 |
| Example 1 | | | | | | | | | | | |
| Comparative | 891.1 | 904.1 | 934.0 | 1.01 | 1.05 | 891.1 | 935.3 | 938.1 | 1.05 | 1.05 | 4/50 |
| Example 2 | | | | | | | | | | | |
| Comparative | 922.3 | 928.0 | 933.0 | 1.01 | 1.01 | 922.3 | 952.0 | 966.3 | 1.03 | 1.05 | 5/50 |
| Example 3 | | | | | | | | | | | |
| Comparative | 921.4 | 973.0 | 974.0 | 1.06 | 1.06 | 921.4 | 928.1 | 931.4 | 1.01 | 1.01 | 7/50 |
| Example 4 | | | | | | | | | | | |

From Table 1, in the solid-state battery 1 of each of Examples 1 to 5, in the first cross section (FIG. 2) taken along the direction D2, ratios (T1a/T2, T1b/T2) of the thicknesses T1a and T1b of the non-facing portions 61a and 61b in the direction D1 to the thickness T2 of the facing portion 62 in the direction D1 are in a range of 0.93 or more and 0.99 or less. In the solid-state battery 1 of each of Examples 1 to 5, in the second cross section (FIG. 3) taken along the direction D3, ratios (T3a/T4, T3b/T4) of the thicknesses T3a and T3b of the end portions 63a and 63b of the facing portion 62 in the direction D1 to the thickness T4 of the central portion 64 in the direction D1 are in a range of 1.01 or more and 1.07 or less. In all of Examples 1 to 5 in which the ratio of the predetermined portions was within such a range, the number of cracks that occurred was 0 out of 50, and the occurrence of the crack in the solid-state battery 1 was effectively prevented.

From Table 1, in the solid-state battery 1 of each of Comparative Examples 1 to 4, in the second cross section (FIG. 3) taken along the direction D3, ratios (T3a/T4, T3b/T4) of the thicknesses T3a and T3b of the end portions 63a and 63b of the facing portion 62 in the direction D1 to the thickness T4 of the central portion 64 in the direction D1 are in a range of 1.01 or more and 1.06 or less, which is approximately the same as the range obtained in Examples 1 to 5. However, in the solid-state battery 1 of each of Comparative Examples 1 to 4, in the first cross section (FIG. 2) taken along the direction D2, ratios (T1a/T2, T1b/T2) of the thicknesses T1a and T1b of the non-facing portions 61a and 61b in the direction D1 to the thickness T2 of the facing portion 62 in the direction D1 are in a range of 1.01 or more and 1.06 or less. In all of Comparative Examples 1 to 4 in which the ratio of the predetermined portions was within such a range in the first cross section, the occurrence of cracks was observed, and the occurrence of cracks in the solid-state battery I was not sufficiently prevented.

Therefore, in the solid-state battery 1, by setting the ratios (T1a/T2, T1b/T2) of the thicknesses T1a and T1b of the non-facing portions 61a and 61b in the direction D1 to the thickness T2 of the facing portion 62 in the direction D1 to the range of 0.93 or more and 0.99 or less in the first cross section (FIG. 2) taken along the direction D2, it is possible to effectively prevent the occurrence of cracks during firing performed in the production process and the occurrence of cracks which is caused by expansion and contraction during the charging and discharging.

In the solid-state battery 1, by setting the ratios to be in such a range in the first cross section (FIG. 2) taken along the direction D2, and setting the ratios (T3a/T4, T3b/T4) of the thicknesses T3a and T3b of the end portions 63a and 63b of the facing portion 62 in the direction D1 to the thickness T4 of the central portion 64 in the direction D1 to be in the range of 1.01 or more and 1.07 or less in the second cross section (FIG. 3) taken along the direction D3, it is possible to effectively prevent the occurrence of cracks during the firing and the charging and discharging.

The above description is merely indicative of the principles of the present embodiments. A wide variety of modifications and changes may also be made by those skilled in the art. The present invention is not limited to the precise configurations and example applications indicated and described above, and all appropriate modifications and equivalents are regarded as falling within the scope of the present invention as defined by the appended patent claims and their equivalents.

### REFERENCE SIGNS LIST

1 solid-state battery
2 battery body
2a, 2b, 2c, 2d end surface
3, 4 external electrode
10 first electrode layer
11, 12, 13, 14, 21, 22, 23, 24 edge
20 second electrode layer
30 electrolyte layer
40 laminate
50 insulating layer
61a, 61b non-facing portion
62 facing portion
63a, 63b end portion
64 central portion
D1, D2, D3 direction
T1a, T1b, T2, T3a, T3b, T4 thickness

1. A solid-state battery comprising:
a battery body including a laminate in which a first electrode layer and a second electrode layer are laminated in a first direction with an electrolyte layer interposed therebetween, and an insulating layer covering the laminate; and
an external electrode provided on a first end surface of the battery body, the first end surface facing a second direction orthogonal to the first direction, wherein
in a cross-sectional view taken along the second direction of the battery body,
an edge of the first electrode layer on a first end surface side is located on the first end surface,
an edge of the second electrode layer on the first end surface side is located inside the first end surface, and
a thickness in the first direction of a non-facing portion which is located on the first end surface side and at which the first electrode layer and the second electrode layer do not face each other in the first direction is 0.93 times or more and 0.99 times or less a thickness in the first direction of a facing portion which is located inside the non-facing portion and at which the first electrode layer and the second electrode layer face each other in the first direction.

2. The solid-state battery according to claim 1, wherein
the battery body has a second end surface facing a third direction orthogonal to the first direction and the second direction, and
in a cross-sectional view taken along the third direction, in the facing portion at which the first electrode layer and the second electrode layer face each other in the first direction, a thickness in the first direction of an end portion on a second end surface side is 1.01 times or more and 1.07 times or less a thickness in the first direction of a central portion inside the end portion.
